(19) United States
(12) Patent Application Publication
(10) Pub. No.: US 2011/0154424 A1
(43) Pub. Date: Jun. 23, 2011

(54) APPARATUS AND METHOD FOR TRANSMITTING VIDEO STREAM

(75) Inventor: Ho-Sook Lee, Daejeon (KR)

(73) Assignee: Electronics and Telecommunications Research Institute, Daejeon (KR)

(21) Appl. No.: 12/885,858

(22) Filed: Sep. 20, 2010

(30) Foreign Application Priority Data
Dec. 18, 2009 (KR) 10-2009-0127408

(51) Int. Cl. H04N 7/173

(52) U.S. Cl. 725/110

(57) ABSTRACT

A video stream transmission apparatus is provided. The video stream transmission apparatus may register an information flow path through which an Internet Protocol (IP)-based data packet is received from an IP network based on snooping information that is received through a cable modem termination device from at least one subscriber terminal, may receive the IP-based data packet directly from an information supply device through the registered information flow path, and may transmit the received IP-based data packet to a Hybrid Fiber Coax (HFC)-based cable network.

### CROSS-REFERENCE TO RELATED APPLICATION

This application claims the benefit of Korean Patent Application No. 10-2009-0127408 filed on Dec. 18, 2009, in the Korean Intellectual Property Office, the disclosure of which is incorporated herein by reference.

### BACKGROUND

1. Field

The present invention relates to an apparatus for transmitting a video stream, and more particularly, to an apparatus and method for transmitting a video stream that may depend on a Data over Cable Service Interface Specification (DOCSIS) headend cable modem termination system, such as a Modular Cable Modem Termination System (M-CMTS), to efficiently process a video data stream flowing from a Hybrid Fiber Coax (HFC)-based cable network into a subscriber network through an Internet Protocol (IP) network.

2. Description of the Related Art

Generally, a digital video service is transmitted using a Moving Picture Experts Group-2 (MPEG-2) Transport Stream (TS) packet stream from a video server of a service provider network to a subscriber terminal. The digital video service is modulated using a frequency channel scheme by Edge Quadrature Amplitude Modulation (EQAM) transmitters in an HFC-based cable network, namely, a service distribution network, and the modulated service may be transmitted to the subscriber terminal.

A video transmission service may typically include, for example a video broadcast service that is provided based on a broadcast transmission scheme. In the video transmission service, a single program may be transmitted for each frequency channel in a cable network, and may be broadcast in a subscriber cell in the cable network.

However, transmission schemes or transmission services are being diversified, for example a multicast video transmission service such as a Switched Digital Video (SDV) service that is provided to only a limited subscriber group, and a user demanded service such as a Video on Demand (VoD) service or a video conference service.

As a result of the regular emergence of an interactive service such as an Internet Protocol television (IPTV), it is difficult to flexibly apply a transmission network structure based on a basic broadcast transmission scheme to various complex video transmission services.

Accordingly, a video service flow needs to be transferred through a DOCSIS-based transmission system in a cable network for transmitting a data service flow and thus, it is possible to accept various video service flows, for example a multicast video service flow, a demanded video service flow, and an interactive video service flow.

However, a high cost may be incurred by introducing a DOCSIS headend cable modem termination system, such as a Modular Cable Modem Termination System (M-CMTS) that is used to transfer a video service flow, which has a large capacity and is sensitive to a network delay, to a cable network subscriber through a DOCSIS-based transmission system.

An M-CMTS, namely a data processing device, is expensive and has a large scale based on a performance, compared with a frequency transmission device such as an EQAM transmitter that is a conventional cable network broadcast transmitter. In other words, introduction of the M-CMTS as a device for transmitting a broadcast video service flow for each headend may cause a considerable cost burden.

### SUMMARY

The foregoing and/or other aspects are achieved by providing a video stream transmission apparatus, including a path processor to register an information flow path through which an Internet Protocol (IP)-based data packet is received from an IP network based on snooping information, the snooping information being received through a cable modem termination device from at least one subscriber terminal; an information receiver to receive the IP-based data packet directly from an information supply device through the registered information flow path; and an information transmitter to transmit the received IP-based data packet to a Hybrid Fiber Coax (HFC)-based cable network.

The foregoing and/or other aspects are achieved by providing a video stream transmission apparatus, including a data packet processor to receive an IP-based data packet through a cable modem termination device from an IP network and to transmit the received IP-based data packet to at least one subscriber terminal; a path processor to register an information flow path through which the IP-based data packet is received from the IP network based on snooping information, the snooping information being received through the cable modem termination device from the at least one subscriber terminal; an information receiver to receive the IP-based data packet directly from an information supply device through the registered information flow path; an information transmitter to transmit the received IP-based data packet to an HFC-based cable network; and an information sharing unit to control DOCSIS domain information and control information to be shared with the cable modem termination device, the control information being used to control the IP-based data packet received from the IP network to be processed based on a DOCSIS-based service flow type.

The foregoing and/or other aspects are achieved by providing a video stream transmission method, including registering an information flow path through which an IP-based data packet is received from an IP network based on snooping information, the snooping information being received through a cable modem termination device from at least one subscriber terminal; receiving the IP-based data packet directly from an information supply device through the registered information flow path; and transmitting the received IP-based data packet to an HFC-based cable network.

The foregoing and/or other aspects are achieved by providing a video stream transmission method, including receiving an IP-based data packet through a cable modem termination device from an IP network; registering an information flow path through which the IP-based data packet is received from the IP network based on snooping information, the snooping information being received through the cable modem termination device from the at least one subscriber terminal; receiving the IP-based data packet directly from an information supply device through the registered information flow path; transmitting the received IP-based data packet to an HFC-based cable network; and controlling DOCSIS domain information and control information to be shared with the cable modem termination device, the control information being used to control the IP-based data packet received from the IP network to be processed based on a DOCSIS-based service flow type.

The foregoing and/or other aspects are achieved by providing a video stream transmission method, including receiving snooped network protocol packet information from a cable modem termination device; determining whether a service flow corresponding to the network protocol packet information is registered; transmitting the network protocol packet information to a network in which the service flow is registered, when the service flow is determined to be registered; receiving a video data packet stream from the network in which the service flow is registered; adding a DOCSIS header to the video data packet stream; and transmitting the video data packet stream, to which the DOCSIS header is added, to a cable modem group through a frequency channel set by the service flow.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating a configuration of a video stream transmission system according to an embodiment of the present invention;

FIG. 2 is a block diagram illustrating a configuration of a video stream transmission apparatus according to an embodiment of the present invention;

FIG. 3 is a flowchart illustrating a video stream transmission method according to an embodiment of the present invention;

FIG. 4 is a diagram illustrating a configuration of a video stream processing system according to another embodiment of the present invention;

FIG. 5 is a block diagram illustrating a configuration of a video stream transmission apparatus according to another embodiment of the present invention;

FIG. 6 is a flowchart illustrating a video stream transmission method according to another embodiment of the present invention; and

FIG. 7 is a flowchart illustrating a video stream transmission method according to still another embodiment of the present invention.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

A video stream processing system according to an embodiment of the present invention may introduce a concept of an Internet Protocol (IP) Set-Top Box (STB) in a subscriber terminal based on an IP-based video transmission structure, and may identify each subscriber terminal using each IP address. Additionally, the video stream processing system may form a multicast session under the control of each subscriber terminal, and may apply a multicast video transmission scheme to a cable network. Here, in the multicast type video transmission scheme, a video program demanded by a subscriber may be transmitted to only a terminal of the subscriber or a terminal group to which the terminal of the subscriber belongs, and a video stream may not flow to a subscriber that does not desire to receive a service.

For example, the video stream processing system may apply a transmission scheme based on a Data Over Cable Service Interface Specification (DOCSIS) 3.0 transmission standard, to transfer IP data within a cable network.

To provide an IP-based video transmission service, a headend in the video stream processing system may include a Modular-Cable Modem Termination System (M-CMTS) device that is a DOCSIS packet processor, and a DOCSIS-Quadrature Amplitude Modulation (D-QAM) channel transmitter that has a function of modulating a frequency signal based on a DOCSIS standard. In a subscriber terminal in the video stream processing system, an IP STB may be used to process IP addresses and data streams, and a DOCSIS Cable Modem (CM) may be configured to demodulator frequency signals and to process DOCSIS packets in a subscriber terminal, in order to transmit an IP packet within the cable network.

Additionally, in the video stream processing system, a video data stream flowing from a video server into the headend of the cable network via an IP network based on an Upper Layer Protocol (UDP) and/or a Real-Time Protocol (RTP) in an IP-based video transmission service structure may be classified into a multicast service flow type or a unicast service flow type for transmitting DOCSIS-related information from the M-CMTS in the headend, and may be subject to scheduling. Also, a header of a DOCSIS Media Access Control (MAC) layer may be added to the video data stream, and the video data stream to which the header is added may be transferred to the DOCSIS CM of the subscriber terminal.

Furthermore, in the video stream processing system, the DOCSIS CM may receive its corresponding service flow data packet based on a Downstream Service Identifier (DSID) depending on the service flow type, may buffer and rearrange the received service flow data packet, and may transfer the service flow data packet to the IP STB.

The video stream processing system may include a single M-CMTS that functions as a master in the headend, and a plurality of dependent video stream transmission apparatuses that are operated depending on the M-CMTS, and accordingly, may dependent to process video data streams flowing to the cable network via the IP network.

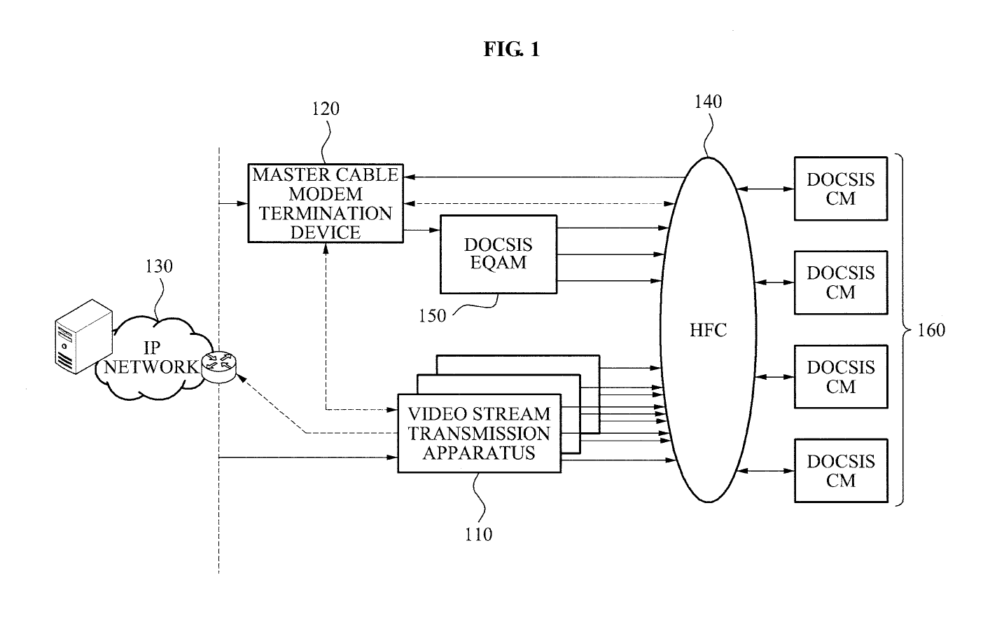

FIG. 1 illustrates a configuration of a video stream processing system according to an embodiment of the present invention.

In the video stream processing system of FIG. 1, a plurality of video stream transmission apparatuses 110 may be implemented by modular transmission apparatuses operated depending on a master cable modem termination device 120 located in a headend. In other words, a plurality of transmission apparatuses may be operated depending on a single master cable modem termination device.

The video stream processing system of FIG. 1 may have a function of a DOCSIS Edge-QAM (EQAM) 150 for physically transmitting a video data stream through a frequency channel. However, the video stream processing system may not need to directly perform data interfacing with the master cable modem termination device 120, and instead, may receive an input of an IP-based video data stream directly via an IP network 130 that is connected to a video supplier.

In other words, the video stream processing system of FIG. 1 may transfer IP-based data packets directly to a Hybrid Fiber Coax (HFC)-based cable network 140 through the video stream transmission apparatus 110, without passing through the master cable modem termination device 120.

Here, the video stream processing system of FIG. 1 may perform a DOCSIS header processing function to process a data packet flowing from the IP network 130 using a DOCSIS-based service flow. Also, the video stream processing system of FIG. 1 may perform a physical layer function of the DOCSIS EQAM 150 to encapsulate the processed DOCSIS data packet in a Moving Picture Experts Group-2 (MPEG-2) Transport Stream (TS) packet and to transmit the encapsulated packet over a frequency channel.

In the video stream processing system of FIG. 1, the master cable modem termination device 120 may perform snooping on a related network protocol unit transmitted through an upstream channel from a subscriber terminal, so that a video data stream transmitted based on a multicast scheme or a unicast scheme may flow to the video stream transmission apparatuses 110, without passing through the master cable modem termination device 120.

Specifically, the master cable modem termination device 120 may perform, using an upstream data processor (not shown), snooping on a network protocol unit, such as an Internet Group Multicast Protocol (IGMP) or an Address Resolution Protocol (ARP), with respect to service flows that are registered to be received through the video stream transmission apparatuses 110, and may obtain snooping information. The master cable modem termination device 120 may transfer the snooping information to the video stream transmission apparatuses 110, not to a network.

When the snooping information is received, the video stream transmission apparatus 110, instead of the master cable modem termination device 120, may transfer information regarding the IGMP or the ARP through the IP network 130, and may register a path through which video data streams flow from the network, so that the video data streams may flow through the registered path.

In the video stream processing system of FIG. 1, there is no need to perform transceiving DOCSIS management messages with at least one DOCSIS CMs 160 in the subscriber terminal. Additionally, any available CMs enabling service may be regarded as a service group belonging to the master cable modem termination device 120.

Thus, according to the embodiment of the present invention, a DOCSIS MAC operation, an initialization operation of a physical layer, and a registration operation that are required for upstream and/or downstream channel transmission may be performed between the master cable modem termination device 120 and the DOCSIS CMs 160.

Specifically, to transmit information on a downstream frequency channel to the at least one DOCSIS CMs 160, the video stream transmission apparatuses 110 may periodically transmit a DOCSIS MAC Domain Descriptor (MDD) message through a frequency channel. All channel resources in the video stream transmission apparatuses 110 may be initialized and set by the master cable modem termination device 120.

In other words, the video stream processing system of FIG. 1 may recognize a downstream channel resource belonging to a DOCSIS domain of the master cable modem termination device 120. Accordingly, all service flows processed by the video stream transmission apparatuses 110 may be regarded as belonging to the DOCSIS domain of the master cable modem termination device 120 and thus, may be set and controlled by the master cable modem termination device 120.

The video stream processing system of FIG. 1 may further include a control interface (not shown) to share DOCSIS domain information and service flow control information with the master cable modem termination device 120. Here, the video stream transmission apparatuses 110 may have outputs that conform to an output standard of the DOCSIS EQAM 150.

Hereinafter, a video stream transmission method will be described in view of the video stream transmission apparatuses 110.

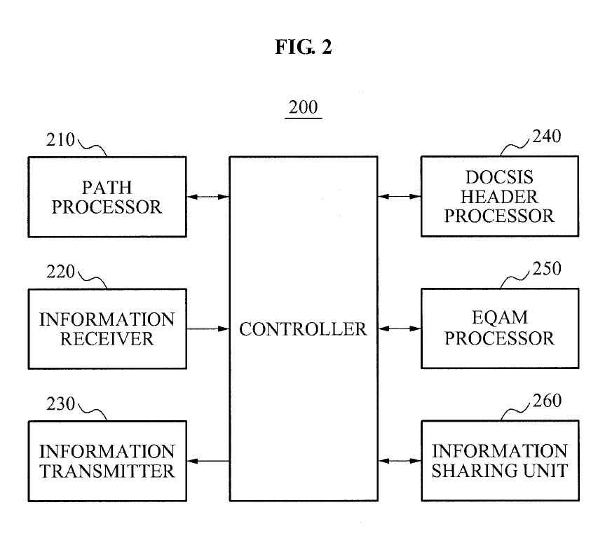

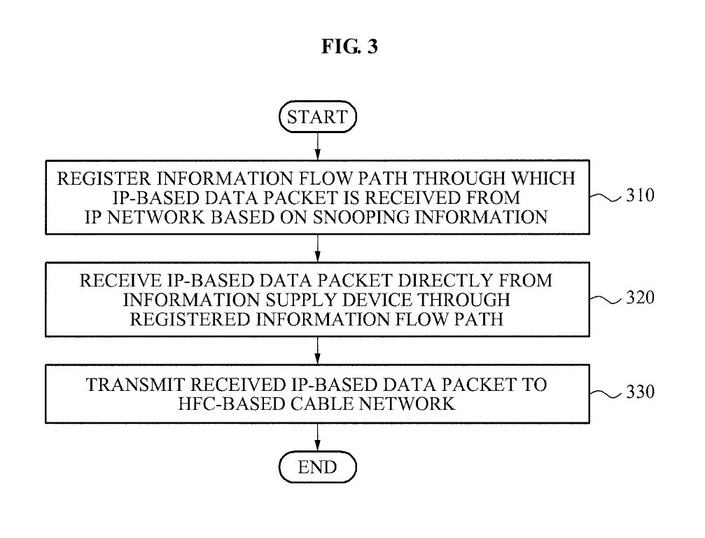

FIG. 2 illustrates a configuration of a video stream transmission apparatus 200 according to an embodiment of the present invention, and FIG. 3 illustrates a flowchart of a video stream transmission method according to an embodiment of the present invention.

The video stream transmission apparatus 200 of FIG. 2 includes a path processor 210, an information receiver 220, and an information transmitter 230.

Referring to FIGS. 2 and 3, the path processor 210 of the video stream transmission apparatus 200 may register an information flow path through which an IP-based data packet is received from an IP network based on snooping information that is received through a cable modem termination device from at least one subscriber terminal in operation 310.

Here, the IP-based data packet may be contained in an IP-based video data stream received via the IP network from an information supply device. The snooping information may refer to information on a network protocol unit that is snooped by the cable modem termination device and transmitted through an upstream channel from the at least one subscriber terminal.

The information receiver 220 of the video stream transmission apparatus 200 may receive the IP-based data packet directly from the information supply device through the registered information flow path in operation 320.

Subsequently, the information transmitter 230 of the video stream transmission apparatus 200 may transmit the received IP-based data packet to the HFC-based cable network in operation 330.

Additionally, the video stream transmission apparatus 200 may further include a DOCSIS header processor 240, an EQAM processor 250, and an information sharing unit 260.

The DOCSIS header processor 240 may control the IP-based data packet received from the IP network to be processed based on a DOCSIS-based service flow type.

The EQAM processor 250 may control the processed IP-based data packet to be encapsulated and transmitted to the HFC-based cable network through a frequency channel.

The information sharing unit 260 may control DOCSIS domain information and control information to be shared with the cable modem termination device. Here, the control information may be provided by the DOCSIS header processor 240.

Hereinafter, a video stream processing system according to another embodiment of the present invention will be described.

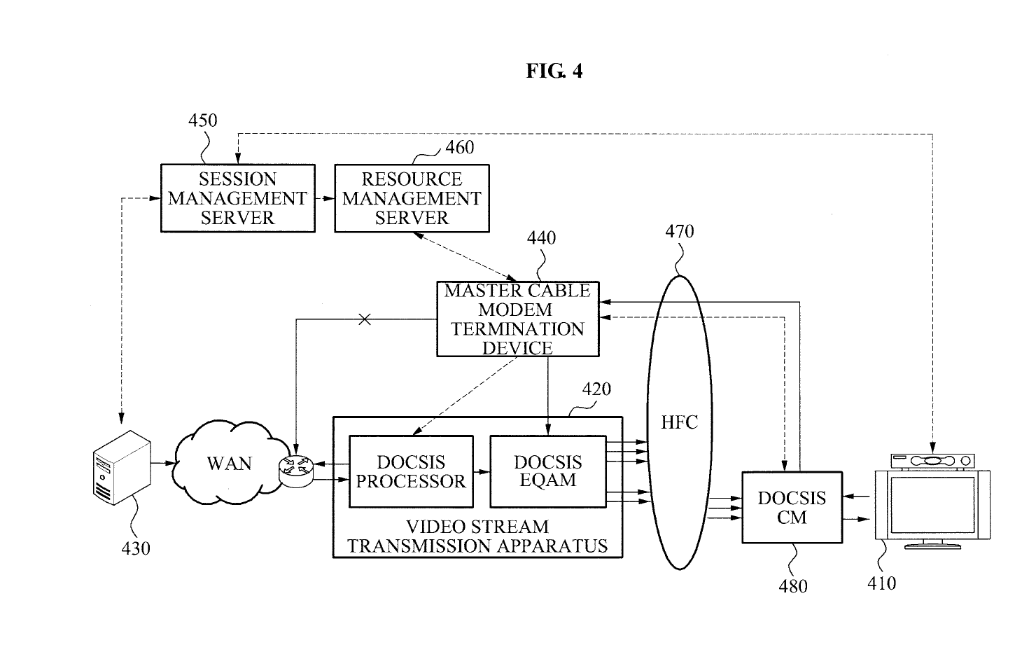

FIG. 4 illustrates a configuration of a video stream processing system according to another embodiment of the present invention.

The video stream processing system of FIG. 4 may include a data interface with a DOCSIS External PHY Interface (DEPI) standard, to provide data interfacing with a master cable modem termination device 440, so that a general data service flow flowing from a network through the master cable modem termination device 440 may be transmitted through a downstream channel.

When a DOCSIS service flow processing function of the video stream processing system of FIG. 4 is inactivated, a function of a DOCSIS-EQAM may be performed.

In the video stream processing system of FIG. 4, an IP STB 410 of a subscriber terminal may transfer IP-based channel change information or program session request information to a session management server 450 of a cable provider network through a protocol.

The video stream processing system of FIG. 4 may reserve an available frequency channel resource through an interaction between the session management server 450 and a frequency management server 460. Here, the frequency channel resource may satisfy a transmission Quality of Service (QoS) used to transmit a video program. The frequency management server 460 may manage the frequency channel resource.

Here, when there is no IP group session used to transmit a service from a video server 430 to a subscriber, the video stream processing system of FIG. 4 may request the video server 430 to set an IP group session.

Additionally, the resource management server 460 may receive the registered frequency channel resource from the master cable modem termination device 440, and may manage the registered frequency channel resource. Here, the frequency channel resource may be used to transmit a video program. Additionally, the master cable modem termination device 440 may set a frequency channel resource used to transmit a video stream, and may control a connection of the frequency channel resource.

General data packets flowing from a network of the video stream processing system of FIG. 4 may pass through the master cable modem termination device 440, and may be transmitted to a subscriber of a cable network via a DEPI of a video stream transmission apparatus 420.

The video stream transmission apparatus 420 may receive a video data stream flowing from the network directly, without passing through the master cable modem termination device 440, may perform header processing and scheduling of a DOCSIS service flow, and may transfer the DOCSIS service flow to the subscriber terminal via the cable network.

The master cable modem termination device 440 may perform snooping on a network protocol unit such as an IGMP or an ARP that is transferred through an upstream channel, to obtain snooping information. The snooping information may be transferred through a control message from the master cable modem termination device 440 to the video stream transmission device 420, not to the network, so that the video stream transmission apparatus 420 may process the video data stream flowing from the network.

When the snooping information is received from the master cable modem termination device 440, the video stream transmission apparatus 420 may transfer the received snooping information to the network, instead of the master cable modem termination device 440. Routing devices in the network may induce a path to be set so that video data packets may flow into the video stream transmission apparatus 420 through the path.

Subsequently, the video data packets flowing to the video stream transmission apparatus 420 may be subject to the scheduling and the header processing based on set characteristics of the DOCSIS service flow. The processed video data packets may be transferred by the DOCSIS EQAM to the subscriber terminal through an HFC network 470 and via a DOCSIS CM 480.

In other words, the IP-based video stream processed by the video stream transmission apparatus 420 may be finally transmitted to the IP STB 410. Thus, it is possible to provide a multicast type or unicast type video transmission service for each subscriber terminal through a scheme as described above.

Hereinafter, another video stream transmission method will be described in view of the video stream transmission apparatus 420.

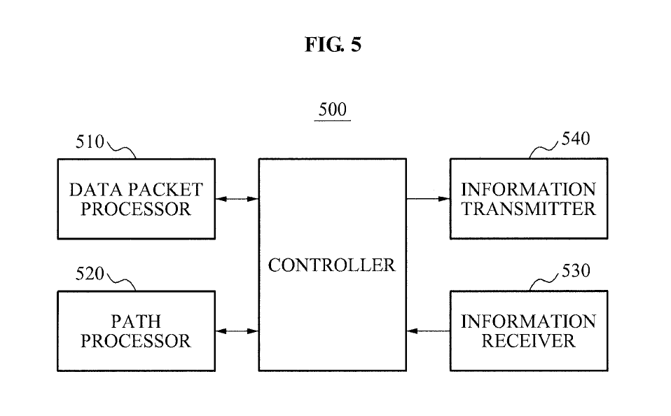

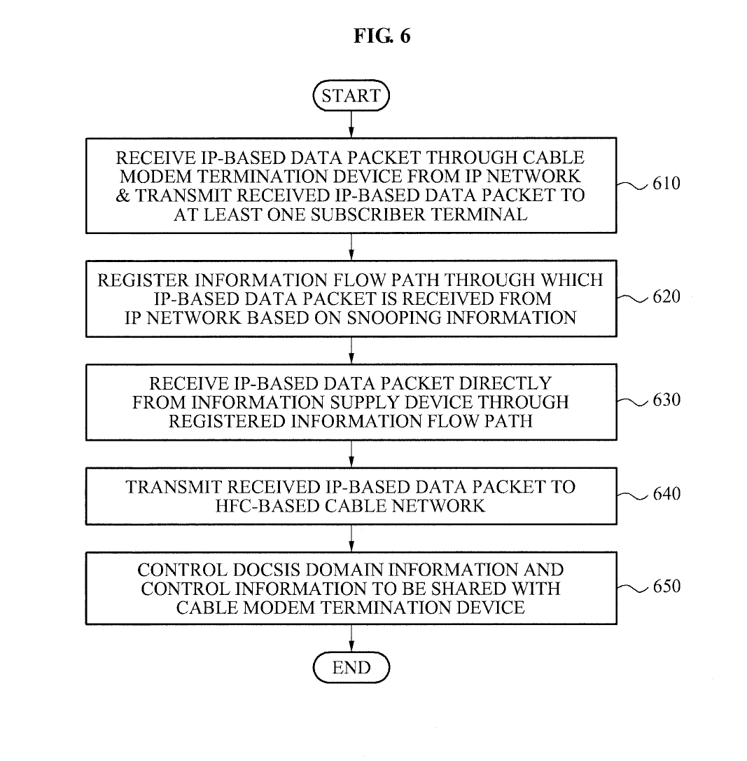

FIG. 5 illustrates a configuration of a video stream transmission apparatus 500 according to another embodiment of the present invention, and FIG. 6 illustrates a flowchart of a video stream transmission method according to another embodiment of the present invention.

The video stream transmission apparatus 500 of FIG. 5 includes a data packet processor 510, a path processor 520, an information receiver 530, and an information transmitter 540.

Referring to FIGS. 4 and 5, the video stream transmission apparatus 500 may receive, using the data packet processor 510, an IP-based data packet through a cable modem termination device from an IP network, and may transmit the received data packet to at least one subscriber terminal in operation 610.

Here, the at least one subscriber terminal may transmit channel change information or program session request information to a session management server of an information supply device.

The session management server may receive the channel change information or the program session request information from the at least one subscriber terminal. Specifically, the session management server may be connected to a resource management server for managing frequency channel resources, and may reserve a frequency channel resource that satisfies a transmission QoS used to transmit video program information. When there is no IP group session used to transmit a service from a video server to the at least one subscriber terminal, the session management server may request the video server to set an IP group session.

The resource management server may register the frequency channel resource in the cable modem termination device, and may manage the registered frequency channel resource. Here, the frequency channel resource may be used to transmit a video program corresponding to the video program information.

Subsequently, the video stream transmission apparatus 500 may register, using the path processor 520, an information flow path through which an IP-based video data stream is received from the IP network based on snooping information that is received through the cable modem termination device from the at least one subscriber terminal in operation 620.

Here, the snooping information may refer to information on a network protocol unit that is snooped by the cable modem termination device and transmitted through an upstream channel from the at least one subscriber terminal, as described above.

The video stream transmission apparatus 500 may receive, using the information receiver 530, the IP-based data packet directly from the information supply device through the registered information flow path in operation 630.

The video stream transmission apparatus 500 may transmit, using the information transmitter 540, the received IP-based data packet to an HFC-based cable network in operation 640.

Additionally, the video stream transmission apparatus 500 may further include an information sharing unit (not shown).

Specifically, the video stream transmission apparatus 500 may control, using the information sharing unit, DOCSIS domain information and control information to be shared with the cable modem termination device in operation 650. Here, the control information may be used to control the IP-based data packet received from the IP network to be processed based on a DOCSIS-based service flow type.

Another video stream transmission method according to still another embodiment of the present invention may be performed.

Specifically, when snooped information on a network protocol packet such as an IGMP packet and an ARP packet is received from a master cable modem termination device, a video stream transmission apparatus according to still another embodiment of the present invention may determine whether a service flow corresponding to the received information is registered. When the service flow is determined to be registered, the video stream transmission apparatus may transfer the IGMP packet and ARP packet to a network.

When information on the IGMP packet and ARP packet for a service flow that is not registered is received, the video stream transmission apparatus may terminate a process, abstaining from performing the above processing.

When the video stream transmission apparatus transfers the IGMP packet and ARP packet to the network, a video stream to be transmitted to a corresponding video session may flow to the video stream transmission apparatus from the network. Subsequently, a DOCSIS header may be added to the video stream flowing into the video stream transmission apparatus, and the video stream to which the DOCSIS header is added may be transmitted to a service group of a corresponding CM via a frequency channel set by the service flow, through the scheduling operation.

Additionally, the video stream transmission apparatus may receive setting information for transmission of the service flow from the cable modem termination device, and may perform device setting.

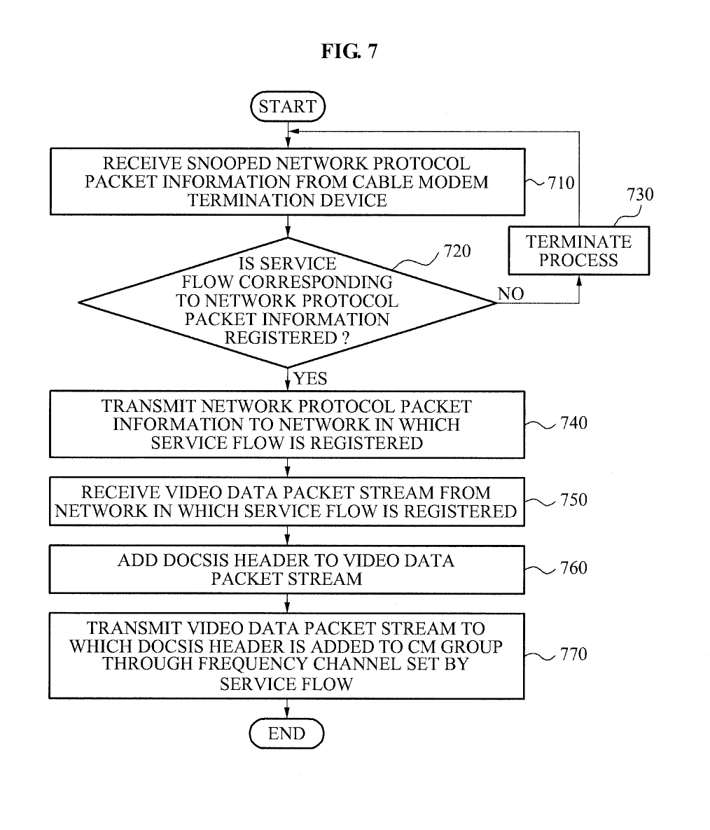

FIG. 7 illustrates a flowchart of a video stream transmission method according to still another embodiment of the present invention.

Referring to FIG. 7, a video stream transmission apparatus according to still another embodiment of the present invention may receive snooped network protocol packet information from a cable modem termination device in operation 710, and may determine whether a service flow corresponding to the network protocol packet information is registered in operation 720.

When the service flow is determined not to be registered, the video stream transmission apparatus may terminate a corresponding process in operation 730. Conversely, when the service flow is determined to be registered, the video stream transmission apparatus may transmit the network protocol packet information to a network in which the service flow is registered in operation 740.

When the network protocol packet information is transmitted to the network in which the service flow is registered, the video stream transmission apparatus may receive a video data packet stream from the network in which the service flow is registered in operation 750.

Subsequently, the video stream transmission apparatus may add a DOCSIS header to the received video data packet stream in operation 760, and may transmit the video data packet stream, to which the DOCSIS header is added, to a CM group through a frequency channel set by the service flow in operation 770.

Here, the video stream transmission apparatus may receive setting information of the service flow from the cable modem termination device, and may control a setting of the service flow, as described above.

According to embodiments of the present invention, it is possible to more efficiently provide a multicast video broadcast flow and a real-time video service flow that flow from an IP network, and it is also possible to develop a digital broadcast service to an IP-based broadcast service by minimizing use of an expensive M-CMTS device. Additionally, it is possible to efficiently use network resources and to flexibly provide an interactive IP video service.

Additionally, according to embodiments of the present invention, it is possible to build a DOCSIS MAC domain between CMs of subscribers by setting an M-CMTS device located in a headend as a master, and to enable a plurality of video stream transmission apparatuses operated depending on the M-CMTS device to take exclusive charge of service flow transmission processing, such as DOCSIS header processing, with respect to a video data stream flowing in the headend. Thus, it is possible to efficiently process an IP-based video service flow.

Furthermore, according to embodiments of the present invention, it is possible to define a concept, a function and a processing procedure of a video stream transmission apparatuses dependent on an M-CMTS, and to perform a scheme of applying a device control structure and a network configuration to enable a device to be dependent on the M-CMTS, and a transmission processing of a video service flow.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A video stream transmission apparatus, comprising:
a path processor to register an information flow path through which an Internet Protocol (IP)-based data packet is received from an IP network based on snooping information, the snooping information being received through a cable modem termination device from at least one subscriber terminal;
an information receiver to receive the IP-based data packet directly from an information supply device through the registered information flow path; and
an information transmitter to transmit the received IP-based data packet to a Hybrid Fiber Coax (HFC)-based cable network.

2. The video stream transmission apparatus of claim 1, wherein the IP-based data packet is contained in an IP-based video data stream received via the IP network from the information supply device.

3. The video stream transmission apparatus of claim 1, further comprising:
a Data Over Cable Service Interface Specification (DOCSIS) header processor to control the IP-based data packet to be processed based on a DOCSIS-based service flow type, the IP-based data packet being received from the IP network; and
an Edge Quadrature Amplitude Modulation (EQAM) processor to control the processed IP-based data packet to be encapsulated and transmitted to the HFC-based cable network through a frequency channel.

4. The video stream transmission apparatus of claim 3, further comprising:
an information sharing unit to control DOCSIS domain information and control information to be shared with the cable modem termination device, the control information being provided by the DOCSIS header processor.

5. The video stream transmission apparatus of claim 1, wherein the snooping information comprises information on a network protocol unit that is snooped by the cable modem termination device and transmitted through an upstream channel from the at least one subscriber terminal.

6. A video stream transmission apparatus, comprising:
a data packet processor to receive an IP-based data packet through a cable modem termination device from an IP network and to transmit the received IP-based data packet to at least one subscriber terminal;
a path processor to register an information flow path through which the IP-based data packet is received from the IP network based on snooping information, the snooping information being received through the cable modem termination device from the at least one subscriber terminal;
an information receiver to receive the IP-based data packet directly from an information supply device through the registered information flow path;
an information transmitter to transmit the received IP-based data packet to an HFC-based cable network; and
an information sharing unit to control DOCSIS domain information and control information to be shared with the cable modem termination device, the control information being used to control the IP-based data packet received from the IP network to be processed based on a DOCSIS-based service flow type.

7. The video stream transmission apparatus of claim 6, wherein the at least one subscriber terminal transmits channel change information or program session request information to a session management server of the information supply device.

8. The video stream transmission apparatus of claim 7, wherein the session management server is connected to a resource management server to reserve a frequency channel resource, and requests a video server to set an IP group session when there is no IP group session used to transmit a service from the video server to the at least one subscriber terminal, the resource management server managing the frequency channel resource, and the frequency channel resource satisfying a transmission Quality of Service (QoS) used to transmit video program information.

9. The video stream transmission apparatus of claim 8, wherein the resource management server registers the frequency channel resource in the cable modem termination device and manages the registered frequency channel resource, the frequency channel resource being used to transmit a video program corresponding to the video program information.

10. The video stream transmission apparatus of claim 9, wherein the cable modem termination device controls a setting and connection of the frequency channel resource used to transmit the video program.

11. The video stream transmission apparatus of claim 6, wherein the snooping information comprises information on a network protocol unit that is snooped by the cable modem termination device and transmitted through an upstream channel from the at least one subscriber terminal.

12. A video stream transmission method, comprising:
registering an information flow path through which an IP-based data packet is received from an IP network based on snooping information, the snooping information being received through a cable modem termination device from at least one subscriber terminal;
receiving the IP-based data packet directly from an information supply device through the registered information flow path; and
transmitting the received IP-based data packet to an HFC-based cable network.

13. The video stream transmission method of claim 12, further comprising:
controlling the IP-based data packet to be processed based on a DOCSIS-based service flow type, the IP-based data packet being received from the IP network; and
controlling the processed IP-based data packet to be encapsulated and transmitted to the HFC-based cable network through a frequency channel.

14. The video stream transmission method of claim 12, wherein the snooping information comprises information on a network protocol unit that is snooped by the cable modem termination device and transmitted through an upstream channel from the at least one subscriber terminal.

15. A video stream transmission method, comprising:
receiving an IP-based data packet through a cable modem termination device from an IP network;
registering an information flow path through which the IP-based data packet is received from the IP network based on snooping information, the snooping information being received through the cable modem termination device from the at least one subscriber terminal;
receiving the IP-based data packet directly from an information supply device through the registered information flow path;
transmitting the received IP-based data packet to an HFC-based cable network; and
controlling DOCSIS domain information and control information to be shared with the cable modem termination device, the control information being used to control the IP-based data packet received from the IP network to be processed based on a DOCSIS-based service flow type.

16. The video stream transmission method of claim 15, further comprising:
transmitting, by the at least one subscriber terminal, channel change information or program session request information to a session management server of the information supply device;
connecting, by the session management server, to a resource management server and reserving a frequency channel resource, the resource management server managing the frequency channel resource, and the frequency channel resource satisfying a transmission QoS used to transmit video program information; and
requesting, by the session management server, a video server to set an IP group session when there is no IP group session used to transmit a service from the video server to the at least one subscriber terminal.

17. The video stream transmission method of claim 15, further comprising:
registering, by the resource management server, the frequency channel resource in the cable modem termination device and managing the registered frequency channel resource, the frequency channel resource being used to transmit a video program corresponding to the video program information; and
controlling, by the cable modem termination device, a setting and connection of the frequency channel resource used to transmit the video program.

18. The video stream transmission method of claim 15, wherein the snooping information comprises information on a network protocol unit that is snooped by the cable modem termination device and transmitted through an upstream channel from the at least one subscriber terminal.

19. A video stream transmission method, comprising:
receiving snooped network protocol packet information from a cable modem termination device;
determining whether a service flow corresponding to the network protocol packet information is registered;
transmitting the network protocol packet information to a network in which the service flow is registered, when the service flow is determined to be registered;
receiving a video data packet stream from the network in which the service flow is registered;
adding a DOCSIS header to the video data packet stream; and
transmitting the video data packet stream, to which the DOCSIS header is added, to a cable modem group through a frequency channel set by the service flow.

20. The video stream transmission method of claim 19, further comprising:
receiving setting information of the service flow from the cable modem termination device and controlling a setting of the service flow based on the received setting information.
